(19) United States
(12) Patent Application Publication
(10) Pub. No.: US 2018/0214833 A1
(43) Pub. Date: Aug. 2, 2018

(54) APPARATUS FOR HEATING OR COOLING RAW MATERIAL

(71) Applicant: SHIN NICHINAN CO., LTD., Kitakyushu-Shi, Fukuoka (JP)

(72) Inventors: Yoichi KASHIMA, Yokohama-shi, Kanagawa (JP); Yusuke TAKEMOTO, Yokohama-shi, Kanagawa (JP); Takahiro SHIBUYA, Yokohama-shi, Kanagawa (JP); Kento HIRASE, Yokohama-shi, Kanagawa (JP)

(21) Appl. No.: 15/747,518

(22) PCT Filed: May 24, 2016
(86) PCT No.: PCT/JP2016/065291

§ 371 Date: Jan. 25, 2018

(30) Foreign Application Priority Data
Jul. 29, 2015 (JP) 2015-149255

(51) Int. Cl. B01F 15/06; B01F 7/04; B01F 15/00; B01F 7/10; B01F 7/08; F26B 17/20; F26B 3/20

(52) U.S. Cl. CPC B01F 15/063; B01F 7/042; B01F 15/00032; B01F 7/105; B01F 2015/061; F26B 17/20; F26B 3/20; B01F 2015/062; B01F 7/087

(57) ABSTRACT

An apparatus is equipped with first and second rotary shaft 3, 4 and a plurality of disks 40, 50 provided upright at equal intervals on the respective rotary shaft. The disks are heated or cooled from the inside, and a raw material is heated or cooled by bringing it into contact with the disk surfaces. Scraper members 45, 45′ and 55, 55′ that enter between the surfaces of the facing adjacent disks to scrape the raw material are fixed to each of the disks 40, 50. The first and second rotary shafts 3, 4 are rotated at unequal speeds such that the scraper members approach the facing disk surfaces with trajectories drawn thereon varying, so that the raw material that has adhered to the disk surfaces can be effectively scraped off.

### TECHNICAL FIELD

The present invention relates to an apparatus for heating or cooling a raw material while being stirred and conveyed using a mechanism with two shafts that rotate at unequal speeds.

### BACKGROUND ART

Conventionally, a kneading apparatus is known in which two shafts each having a plurality of paddles (blades) erected so as to be arranged helically with an inverse helix to each other are caused to rotate at unequal speeds to knead and convey a raw material in one direction (blow-described Patent Document 1). In such a kneading apparatus, both the rotary shafts are caused to rotate at unequal speeds and the distal end of the paddle sequentially approaches the external peripheral surface of the facing rotary shaft with its phase changing, so that the kneaded object that has adhered to the external peripheral surface of the facing rotary shaft is effectively scraped off, thus performing self-cleaning.

A drying apparatus is also known in which such two rotary shafts that rotate at unequal speeds are provided with a plurality of fan-shaped disks to stir, convey and dry an object such as sludge (blow-described Patent Document 2). In such a kind of drying apparatus, the two rotary shafts and the disks mounted to each rotary shaft are all made hollow and the inside space of each rotary shaft communicates with the inside spaces of the disks, respectively.

Steam is supplied to the inside space of each rotary shaft from one end thereof, and the supplied steam flows from the inside space of the rotary shaft through the inside space of each disk mounted to the rotary shaft to heat the rotary shaft and the surface of the disk. The object to be dried approaches or contacts the disk surface or the surface of the rotary shaft in the process of being stirred and conveyed, so that the object to be dried is heated and dried with its percentage of moisture content reduced. Steam loses heat by that amount and undergoes condensation to drainage.

### PRIOR ART DOCUMENTS

### Patent Documents

Patent Document 1: WO 2009/044608

Patent Document 2: JP 2014-131784

### SUMMARY OF INVENTION

### Problems to be Solved

An object to be dried may have high adhesion depending upon the percentage of moisture content before or after drying when it passes through a given percentage range of moisture content during drying. In the arrangements in Patent Documents 1 and 2, even an object that can be scraped off by the self-cleaning effect due to the unequal rotation of the rotary shafts may have strong adhesion as the drying progresses. This causes the scraping effect to be remarkably deteriorated.

Particularly, in the drying apparatus as disclosed in Patent Document 2, the disk is mounted substantially upright on the rotary shaft and the scraping effect for the disks is originally low, so that the adhesion of the object to be dried progresses gradually. There is thus a problem that the drying efficiency decreases.

As described above, the raw material not only needs heating, but also requires cooling. Also in such a case, the raw material adheres to the disk, and the cooling efficiency for the raw material disadvantageously deteriorates.

The present invention is made in view of such problems and an object thereof is to provide an apparatus for heating or cooling a raw material being capable of increasing the scraping effect for a raw material such as an object to be dried or cooled and being capable of improving the heating or cooling efficiency.

### Means for Solving the Problems

The present invention concerns an apparatus for heating or cooling a raw material in which a disk mounted on a rotary shaft is heated or cooled and the raw material is brought into contact with the disk surface, comprising:

first and second rotary shafts that are disposed in a facing manner;

a plurality of disks that are provided upright at intervals on the first rotary shaft;

a plurality of disks that are provided upright on the second rotary shaft so as to be shifted a predetermined distance from the disks of the first rotary shaft, respectively;

wherein a scraper member that enters between the surfaces of the facing adjacent disks to scrape the raw material is fixed to each disk of the first and second rotary shafts; and

the first and second rotary shafts are rotated at unequal speeds such that the scraper member approaches the facing disk surface with a trajectory drawn thereon varying.

### Effect of the Invention

In the present invention, scraper members for scraping a raw material are fixed to two rotary shafts, which are caused to rotate at unequal speeds. Since the scraper members approach the facing disk surfaces with the trajectories drawn thereon varying, the raw material that has adhered to the disk surfaces is effectively scraped off. This scraping effect improves the heating or cooling efficiency for the raw material.

### BRIEF DESCRIPTION OF DRAWINGS

FIG. 1 is a top view of an apparatus for heating or cooling a raw material, showing disks disposed on rotary shafts with the upper side of a housing being removed;

FIG. 2 is a longitudinal sectional view showing a state in which the disks disposed on the one rotary shaft inside the housing are viewed from the side;

FIG. 3 is a sectional view along the line A-A in FIG. 1;

FIG. 4a is a longitudinal sectional view of the disk;

FIG. 4b is a sectional view along the line B-B in FIG. 4a;

FIG. 5 is a perspective view showing the arrangement of the disks;

FIG. 6 is an illustrative view showing a state in which the scraper member changes in position depending on the rotation of the rotary shaft;

FIG. 7 is an illustrative view showing a state in which the scraper member changes in position when the rotational angle of the rotary shaft is changed finely;

FIG. 8 is an illustrative view showing the movement trajectory of the scraper member mounted on the driven shaft when the drive shaft is fixed;

FIG. 9 is an illustrative view showing the movement trajectory of the scraper member mounted on the drive shaft when the driven shaft is fixed;

FIG. 10 is an illustrative view showing in detail the movement trajectory of the scraper member mounted on the driven shaft when the drive shaft is fixed;

FIG. 11 is an illustrative view showing in detail the movement trajectory of the scraper member mounted on the drive shaft when the driven shaft is fixed; and

FIG. 12 is an illustrative view showing the movement trajectory of the scraper member when the rotational ratio of the rotary shafts are varied.

### MODE OF CARRYING OUT THE INVENTION

In the following, the present apparatus of the invention will be described in detail based on embodiments shown in drawings.

### Embodiments

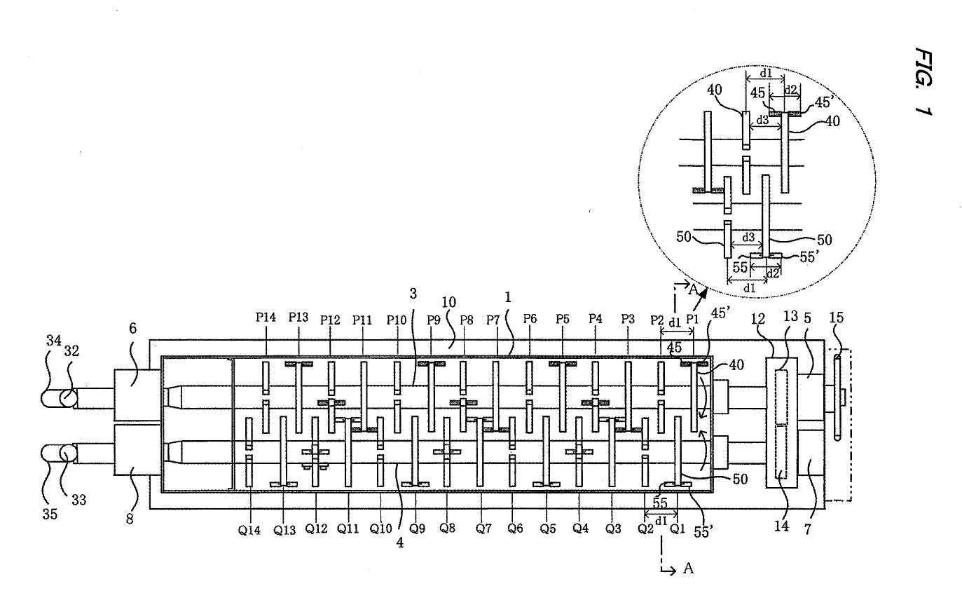

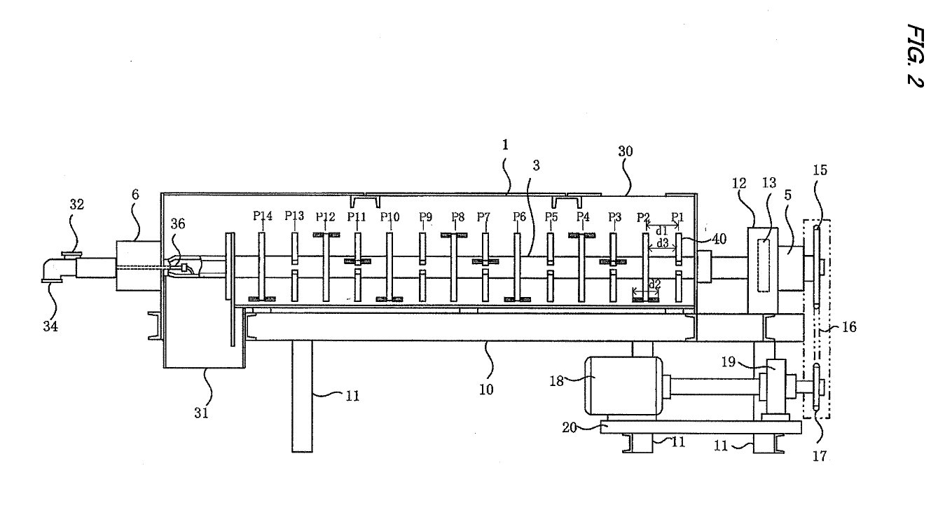

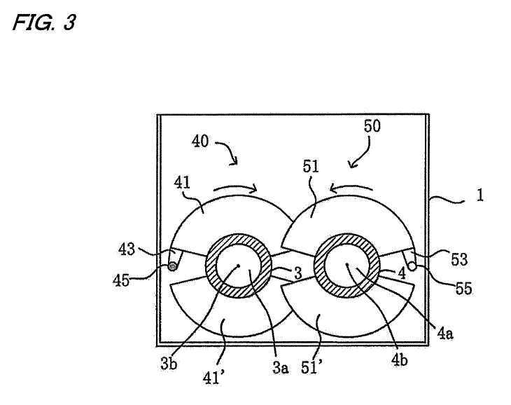

FIGS. 1 through 3 show the structure of a heating or cooling apparatus according to an embodiment of the present invention. FIG. 1 is a top view of the apparatus, showing disks disposed on two rotary shafts with the upper side of a housing being removed; FIG. 2 is a longitudinal sectional view showing a state in which the disks disposed on the one rotary shaft (drive shaft) inside the housing are viewed from the side; and FIG. 3 is a sectional view along the line A-A in FIG. 1.

In FIGS. 1 through 3, reference numeral 1 indicates a housing of an apparatus for heating or cooling a raw material. The housing 1 is installed horizontally on a base 10 that is supported by struts 11. The housing 1 is made of metal such as stainless steel and is formed into a long, thin, rectangular parallelepiped shape.

At the top of the right end shown in FIG. 2, a raw-material supply opening 30 is provided for supplying the raw material from a hopper (not shown) into the housing 1. The raw material includes various materials that are produced in the manufacturing process of factories and have a high percentage of moisture content. This thus requires drying. For example, the raw material includes a by-product that is generated in a manufacturing process of a paper mill and dried for use as fuel. Alternatively, the raw material is such a material as tar or pitch that has rapidly increasing viscosity with cooling and is solidified at room temperature, requiring sufficient cooling up to the solidification temperature range even though it is a low viscous liquid in the vicinity of temperature of 100° C.

The raw material supplied from the raw-material supply opening 30 is heated or cooled while being stirred, as will be described below, and is discharged from a raw-material discharge opening 31 at the left end shown in FIG. 2. Although not shown, the housing 1 is provided at the upper portion with an openable cover so as to be capable of cleaning or repairing inside mechanisms.

Inside the housing 1, two rotary shafts 3 and 4 of the same cross-sectional shape are provided in parallel to each other in the longitudinal direction. The rotary shafts 3 and 4 are made of metal such as stainless steel and has a cylindrical shape, having inside thereof hollow portions 3a, 4a of a circular cross section (FIG. 3). The rotary shaft 3 is rotatably supported at right and left ends by bearings 5, 6, and the rotary shaft 4 is rotatably supported at right and left ends by bearings 7, 8.

The rotary shafts 3 and 4 have their right ends inserted into a gear box 12. Gears 13 and 14 that mesh with each other are fixed to the rotary shafts 3 and 4 inside the gear box 12.

A sprocket 15 is fixed to the outside of the bearing 5 of the rotary shaft 3. Mounted on a base 20 fixed to the struts 11 is a motor 18 whose output shaft is reduced in speed by reduction gears 19. A sprocket 17 is fixed to the output shaft of the reduction gears 19. A chain 16 is stretched between the sprockets 15 and 17.

A unidirectional rotational drive force from the motor 18 is transmitted to the rotary shaft 3 via the sprocket 17, the chain 16 and the sprocket 15, causing the rotary shaft 3 as a drive shaft (a first rotary shaft) to rotate in one direction, and the rotational drive force is also transmitted to the rotary shaft 4 via the gears 14 and 13, causing the rotary shaft 4 as a driven shaft (a second rotary shaft) to rotate in the opposite direction. The rotary shafts 3 and 4 are caused to rotate via the gears 13 and 14 at unequal speeds with a rotational speed ratio of N:K, wherein N and K are a natural number. For example, N is set to 16 and K to 15 in the present embodiment, and the rotary shafts 3 and 4 are caused to rotate with a rotational speed ratio of 16:15. The rotating directions of the rotary shafts 3 and 4 are such that the shafts rotate inward towards each other when viewed from above, as seen in FIGS. 1 and 3.

Metallic disks 40 as stirring members are mounted on the external periphery of the rotary shaft 3 at equal intervals d1 at a positon Pn (n=1 through 14).

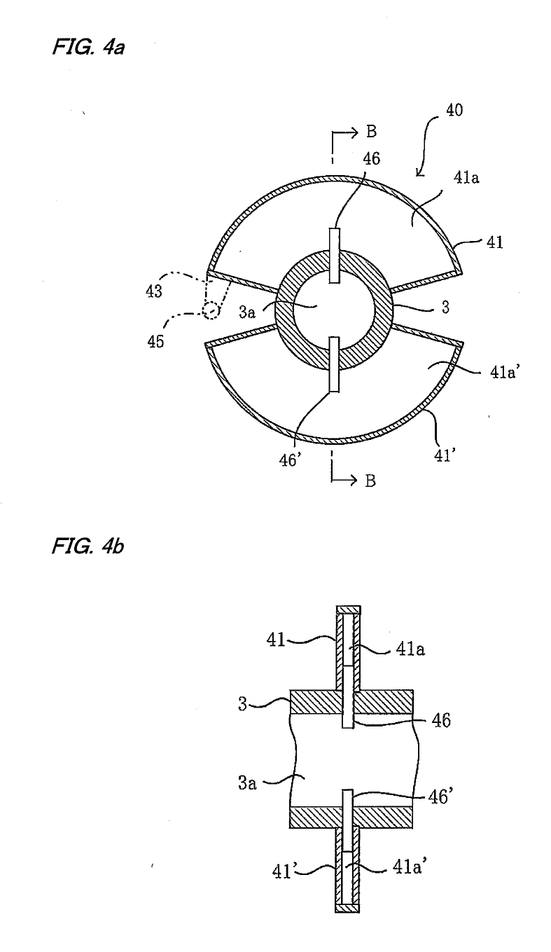

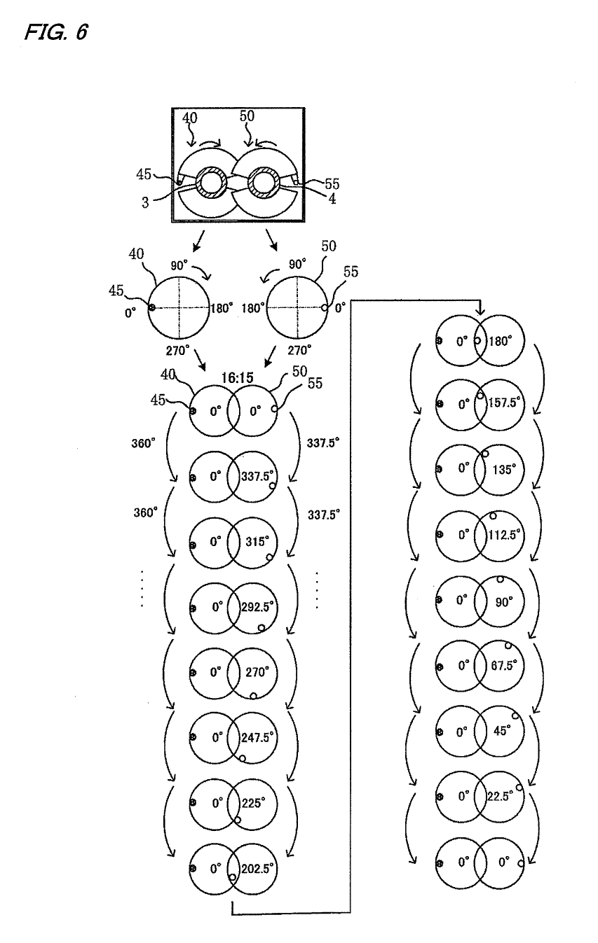

As shown in FIGS. 3 and 4, the disk 40 has a pair of fan-shaped disk blades 41, 41′ that are symmetrical with respect to the horizontal plane. The disk blade 41 is fixed above the rotary shaft 3 perpendicularly thereto by welding or the like, and the disk blade 41′ is fixed below the rotary shaft 3 perpendicularly thereto by welding or the like. Since the disks 41, 41′ are vertically symmetric, the shape drawn by the outer circumferences thereof is circular, having notches at right and left corresponding to the fan shape. The disk 40 thus looks as a whole like a disk that is disposed vertically upright on the rotary shaft 3 concentrically with the axis center 3b thereof. Therefore, the disk 40 is simply shown as a circle in the following description in connection with FIG. 6 and the followings.

Fixed to the outer peripheral end of the disk blade 41 is a metallic mount plate 43 to which a rod- or plate-shaped scraper members 45, 45′ (hereinafter referred to as pins) are fixed in screw type in the direction perpendicular to the mount surface 43 in the forward and backward direction (in the direction along which the rotary shaft 3 extends). As shown in an enlarged view in the upper right of FIG. 1, the distance d2 between the outer ends of the pins 45, 45′ is slightly smaller than the face-to-face distance d3 facing in the axial direction of the adjacent disks 40, 50, and the pins 45, 45′ enter between the adjacent disk surfaces of the facing disks 50 to scrape the raw material that has adhered to the disk surfaces or the facing rotary shaft 4.

Similarly, metallic disks 50 as stirring members are mounted on the external periphery of the rotary shaft 4 at a positon Qn (n=1 through 14) at the same equal intervals d1 as those of the disks 40. The disk 50 also has a pair of fan-shaped disk blades 51, 51′ that are the same in shape as the disk blades 41, 41′, and the disk blades 51, 51′ are fixed above and below the rotary shaft 4 perpendicularly thereto. The disk 50 also looks as a whole like a disk that is disposed vertically upright on the rotary shaft 4 concentrically with the axis center 4b thereof. Therefore, the disk 50 is also simply shown as a circle in the following description in connection with FIG. 6 and the followings.

Pins 55, 55′ that are similar to the pins 45, 45′ are fixed in a similar manner to a metallic mount plate 53 on the outer peripheral end of the disk blade 51. As shown in an enlarged view in the upper right of FIG. 1, the distance between the outer ends of the pins 55, 55′ is the same as the distance d2 between the outer ends of the pins 45, 45′, and it is slightly smaller than the face-to-face distance d3 facing in the axial direction of the adjacent disks 40, 50. The pins 55, 55′ enter between the adjacent disk surfaces of the facing disks 40 to scrape the raw material that has adhered to the disk surfaces or the facing rotary shaft 3. Half-tone dots are drawn in the pins 45, 45′ of the disk 40 in order to distinguish from the pins 55, 55′ of the rotary shaft 4. The pins 45, 45′ are separate, but may be one continuous pin. This also applies to the pins 55, 55′. The pins 45, 45′ and the pins 55, 55′ are made of metal, but can also be made of resin, and they are circular, polygonal or rectangular in cross-sectional shape with a scraping brush also being attached to the tip thereof.

As shown in FIG. 1, the disks 40 are mounted on the rotary shaft 3 such that the pins 45, 45′ take an angle of 0 degree at the position Pn (n=1), taking an angle incremented by 96 degrees in the clockwise direction every time n increments by 1. However, the increments from P3 to P4, from P7 to P8 and from P11 to P12 are set to 72 degrees in order to set the pin angles at P5, P9 and P13 to 0 degree. The disks 50 are mounted on the rotary shaft 4 such that the pins 55, 55′ take an angle of 0 degree at the position Qn (n=1) shifted d1/2 leftward from the position P1 so as to be incremented by 90 degrees in the counterclockwise direction every time n increments by 1. This causes the pins 45, 45′ and the pins 55, 55′ to be arranged helically with an inverse helix and the incremental angular ratio 96:90 degrees to be equal to the speed ratio 16:15 of the rotary shafts 3, 4, so that the raw material is conveyed to the discharge opening 31 at substantially the same conveyance speed. As will be described below, the pins of both the disks enter between the facing disks as the rotary shafts rotate with trajectories drawn thereon varying, and the raw material that has adhered to the disk surface is scraped off therefrom. The pins facing to each other can be prevented from colliding or interfering by changing parameters such as the speed ratio of the disks 40, 50, pin diameter and the like.

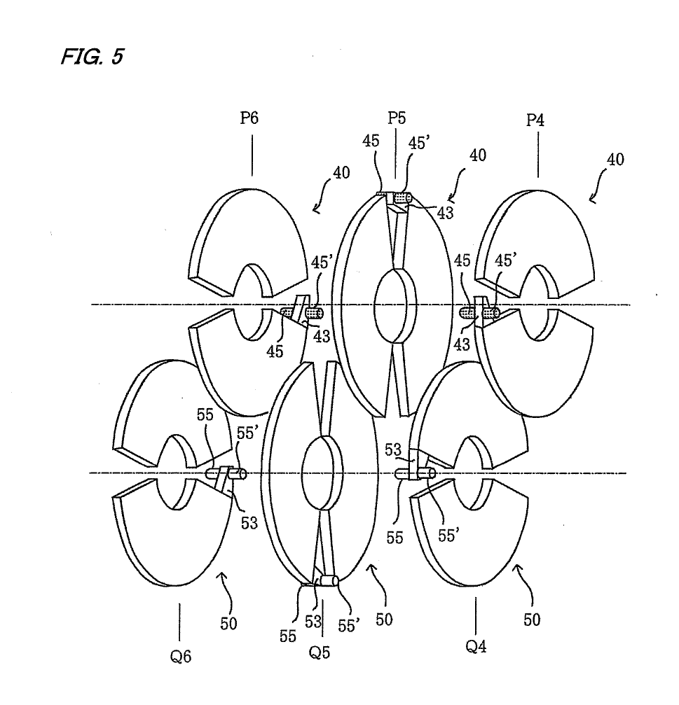

FIG. 5 shows in a perspective view the disks 40, 50 thus arranged. The disks 40, 50 correspond to the disks at the positions P4 through P6 and Q4 through Q6 in FIG. 1. As can be understood from the drawing, the pins 55, 55′ of the disk 50 have the incremental angles of 90 degrees. Therefore, which disk blade the pin mount plate 53 is attached to or the pin position on the mount plate 53 does not change. However, the pins of the disk 40 have the incremental angles of 96 degrees, so that the mount plate 43 is fixed to the other disk blade or the pin position on the mount plate 43 is shifted in the circumferential direction so as to be 96 degrees in incremental angle.

As shown in FIG. 3, the insides of the rotary shafts 3, 4 form hollow portions 3a, 4a, and, as shown in FIGS. 4a and 4b, the insides of the disk blades 41, 41′ also form hollow portions 41a, 41a′. Inserted into the hollow portions 41a, 41a′ are double pipes 46, 46′ that protrude into the hollow portion 3a of the rotary shaft 3. In a case where the raw material is an object to be dried, steam is supplied from a medium supply opening 32 in FIG. 1. The steam is then supplied from the hollow portion 3a of the rotary shaft 3 through the inner pipes of the double pipes 46, 46′ to the hollow portions 41a, 41a′ of the disk blades 41, 41′ to heat the disk blades 41, 41′ from the inside. The steam inside the disk blades 41, 41′ that is cooled in the process of drying the raw material or condensed water produced by cooling is returned to the hollow portion 3a of the rotary shaft 3 through the outer pipes of the double pipes 46, 46′ and discharged from a medium discharge pipe 34 (FIG. 2) through a pipe 36.

On the other hand, in a case where the raw material needs cooling, cooling water is supplied from the medium supply opening 32. The cooling water is supplied from the hollow portion 3a of the rotary shaft 3 through the inner pipes of the double pipes 46, 46′ to the hollow portions 41a, 41a′ of the disk blades 41, 41′ to cool the disk blades 41, 41′ from the inside. The cooling water inside the disk blades 41, 41′ is returned to the hollow portion 3a of the rotary shaft 3 through the outer pipes of the double pipes 46, 46′ and discharged from the medium discharge pipe 34 through the pipe 36.

Although not shown, the insides of the disk blades 51, 51′ also form hollow portions similarly to the disk blades 41, 41′. Double pipes that protrude into the hollow portion 4a of the rotary shaft 4 are inserted into these hollow portions. Steam or cooling water supplied from the medium supply opening 33 is supplied from the hollow portion 4a of the rotary shaft 4 through the inner pipes of the double pipes to the hollow portions of the disk blades 51, 51′, and is returned to the hollow portion 4a of the rotary shaft 4 through the outer pipes of the double pipes for discharge from a medium discharge pipe 35.

Next, the operation of the apparatus thus configured will be described based on an example in which a raw material is heated and dried.

When the motor 18 is driven, a rotational drive force is transmitted to the rotary shaft 3 via the sprocket 17, the chain 16 and the sprocket 15, causing the rotary shaft 3 to rotate in one direction. The rotational drive force is also transmitted to the rotary shaft 4 via the gears 14 and 13, causing the rotary shaft 4 to rotate in the opposite direction with a rotational speed ratio of 16:15 relative to the rotary shaft 3.

When the raw material is supplied from the supply opening 31 and steam is supplied from the medium supply openings 32, 33, the steam is supplied and caused to flow from the hollow portions 3a, 4a of the rotary shafts 3, 4 through the inner pipes of the double pipes to the hollow portions of the disk blades 41, 41′ and 51, 51′. The steam inside the hollow portions 3a, 4a of the rotary shafts 3, 4 and the steam that flows through the hollow portions of the disk blades 41, 41′ and 51, 51′ heat the surfaces of the rotary shafts 3, 4 and the disks 40, 50. The raw material approaches or contacts the disk surface or the surface of the rotary shaft in the process of stirring and conveying, so that the raw material is heated as it advances toward the discharge opening 31. The steam loses heat by that amount and flows as condensed water at the bottom of the rotary shafts 3, 4 for discharge from the medium discharge openings 34, 35.

In the process of drying the raw material, the moisture content decreases depending on the raw material as the drying progresses, and the raw material strongly adheres to the surfaces of the rotary shafts 3, 4 or the disks 40, 50, in some cases causing troubles in rotation with the result that the apparatus malfunctions.

In the present embodiment, the pins provided perpendicularly on the disk surfaces enter between the facing disks as the rotary shafts rotate, and approach the disk surfaces with the phases (trajectories) being varied, allowing the raw material that has strongly adhered to be effectively scraped off. In the following, the scraping effect will be described using FIGS. 6 through 12. In each drawing, the disks 40, 50 are shown as circles as described above, and the pins 45 of the disk 40 are shown as halftone dots and the pins 55 of the disk 50 are shown as being distinguished by white circles. Inside the circles, the rotation angles of the pins or the disks are described.

FIG. 6 shows the angular positions taken by the pins 45, 55 every time the disk 40 of the rotary shaft 3 rotates one revolution (360 degrees) from 0 degree. Since the disks 3, 4 rotate with a rotational speed ratio of 16:15, the disk 50 rotates 360 degrees×(15/16)=337.5 degrees upon rotation of the disk 40 by 360 degrees, thus causing angular retardation of 22.5 degrees. Hereafter, the disk 50 is retarded by 22.5 degrees every time the disk 40 rotates 360 degrees, so that the pins 40, 50 are at the angular positions described in the circles. When the disk 40 rotates 16 times, the disk 50 rotates 15 times.

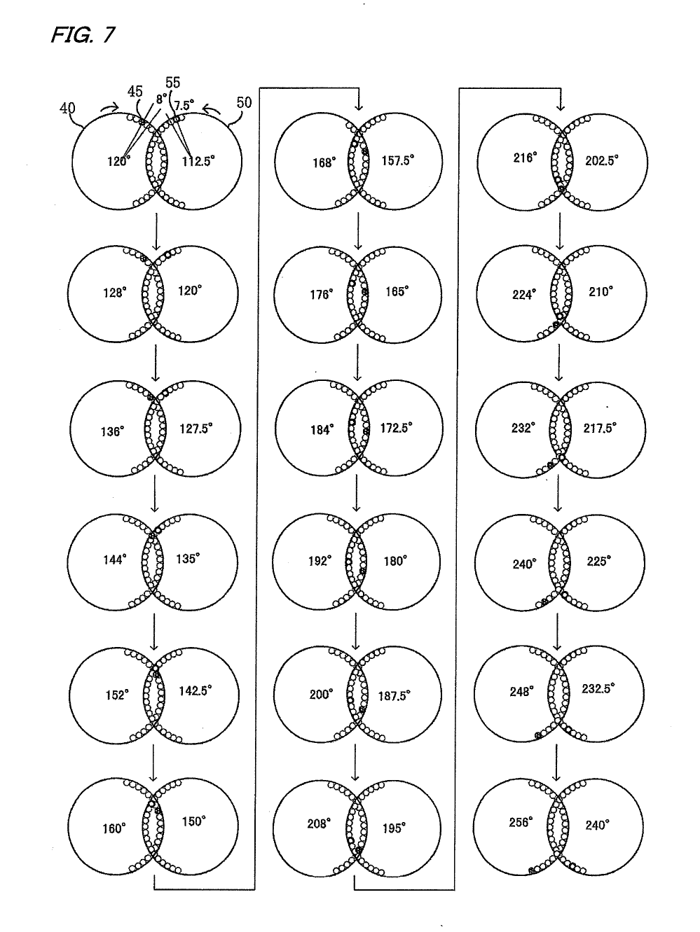

FIG. 7 shows a state in which the pin 45 rotates in increments of 8 degrees from the positon of 120 degrees to the position of 256 degrees during the first one revolution of the disk 40. The pin 55 of the disk 50 takes an angle of 112.5 degrees at the position of 120 degrees of the pin 45, and increments by 7.5 degrees with an increment of 8 degrees of the pin 45, so that the pin 55 takes an angle of 240 degrees when the pin 45 rotates to the angular position of 256 degrees. It is possible to grasp a state in which the pins 45, 55 repeatedly approach each other with the phase varying.

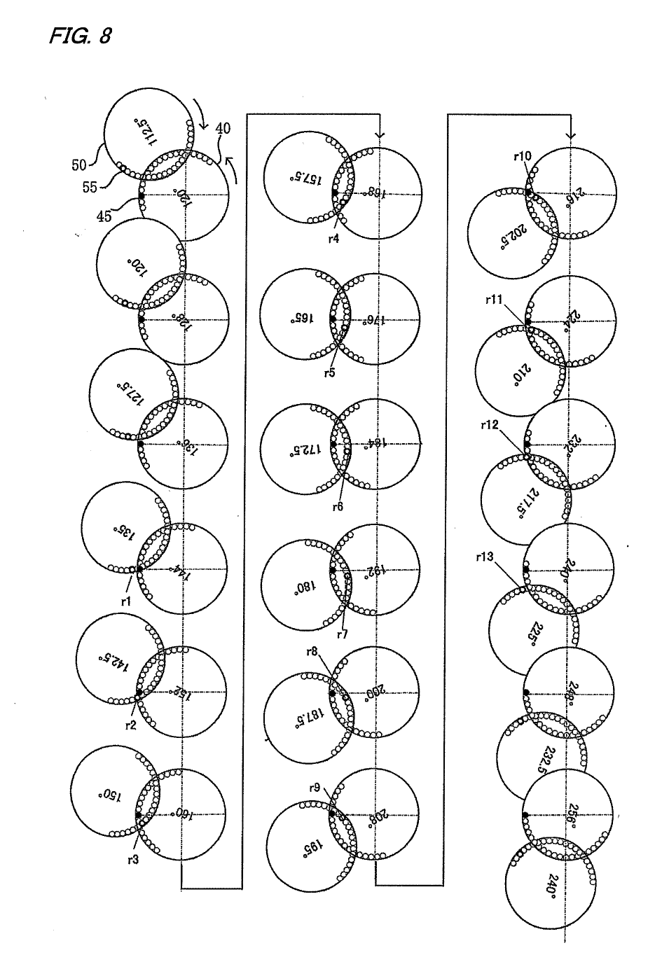

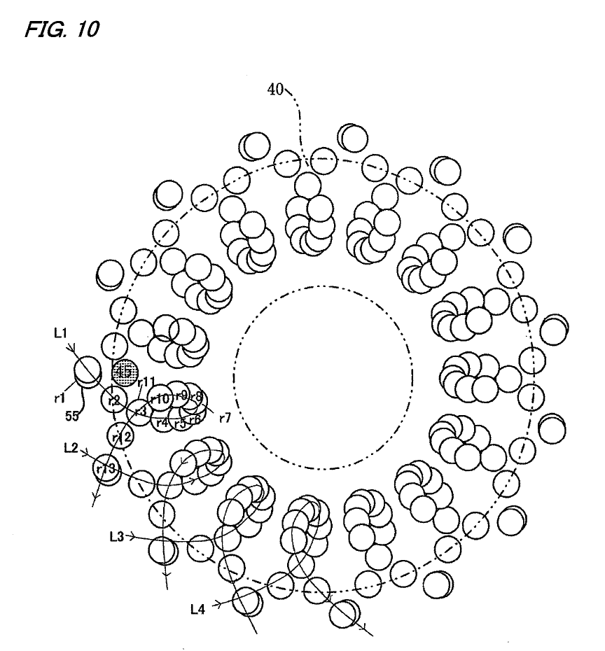

FIG. 8 shows what trajectory the other pin 55 draws when the pin 45 of the disk 40 is fixed at the same position (0 degree). FIG. 10 shows in detail a trajectory L1 that the pin 55 draws from the angular position r1 (135 degrees) to the angular position r13 (225 degrees) in FIG. 8. In FIG. 10, white circles indicate sequentially moving pins 55, and the angular positions r1 to r13 taken by the pin 55 in FIG. 8 are shown in the white circles of the trajectory L1.

As is seen from the drawing, the pin 55 of the disk 50 moves close to the surface of the disk 40 along the trajectory L1 to scrape the raw material that has adhered to the disk surface. When the disk 40 next makes one revolution, the pin 55 of the disk 50 moves close to the surface of the disk 40 along a trajectory L2 different from the trajectory L1 in FIG. 10 to scrape the raw material that has adhered to the disk surface. Hereafter, the scraping is performed respectively along different trajectories L3, L4, every time the disk 40 makes one revolution, returning to the trajectory L1 at the sixteenth revolution. Each trajectory L1, L2, has the same shape, but there are 15 trajectories in one cycle until returning to the trajectory L1, so that each trajectory has a phase difference (shift) of 360 degrees/15=24 degrees, respectively.

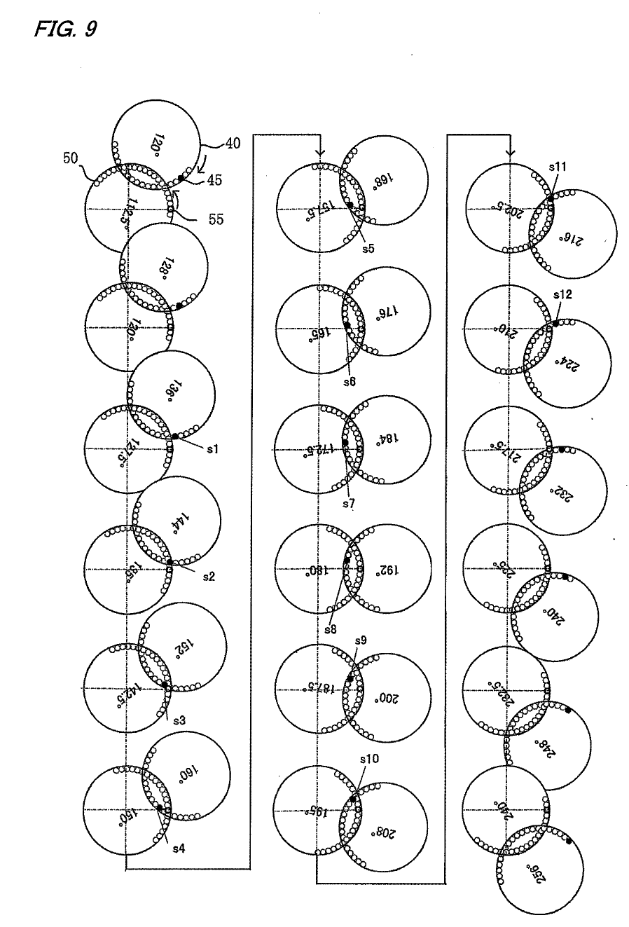

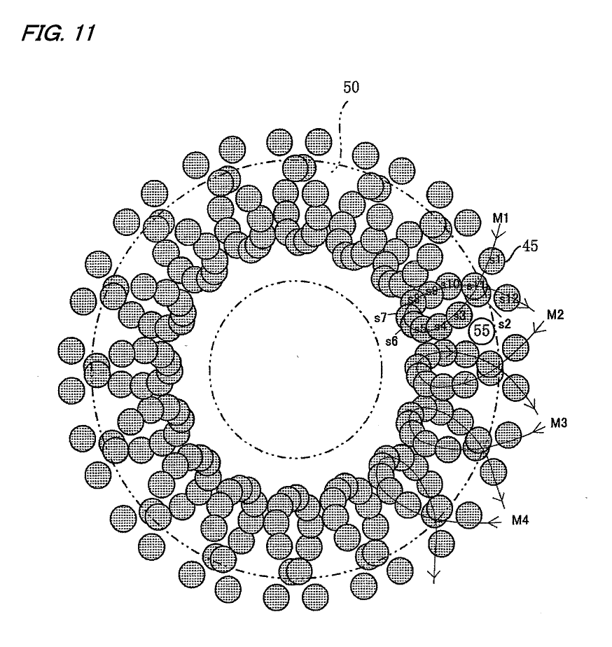

FIG. 9 shows what trajectory the other pin 45 draws when the pin 55 of the disk 50 is fixed at the same position (0 degree). FIG. 11 shows in detail a trajectory M1 that the pin 45 draws from the angular position s1 (136 degrees) to the angular position s12 (224 degrees) in FIG. 9. In FIG. 11, halftone-dot circles indicate sequentially moving pins 45, and the angular positions s1 to s12 taken by the pin 45 in FIG. 9 are shown in the circles of the trajectory M1.

As is seen from the drawing, the pin 45 of the disk 40 moves close to the surface of the disk 50 along the trajectory M1 to scrape the raw material that has adhered to the disk surface. When the disk 50 next makes one revolution, the pin 45 of the disk 40 moves close to the surface of the disk 50 along a trajectory M2 different from the trajectory M1 in FIG. 11 to scrape the raw material that has adhered to the disk surface. Hereafter, the scraping is performed respectively along different trajectories M3, M4, . . . every time the disk 50 makes one revolution, returning to the trajectory M1 at the seventeenth revolution. Each trajectory M1, M2, . . . has the same shape, but there are 16 trajectories in one cycle until returning to the trajectory M1, so that each trajectory has a phase difference (shift) of 360 degrees/16=22.5 degrees, respectively.

When the rotary shafts has the same speed, the trajectory that the pin draws on the other disk surface is always the same and has no phase difference. When, however, the rotary shafts 3, 4 are caused to rotate at unequal speeds with a speed ratio of 16:15 as in this embodiment, the trajectory that the pin of one rotary shaft draws on the other disk surface has a slight deviation for every rotation of 16 or 15 cycles of rotation, as described above. This produces a dense pattern as shown in FIGS. 10 and 11, allowing the raw material adhered to various portions of the disk surface to be effectively scraped off.

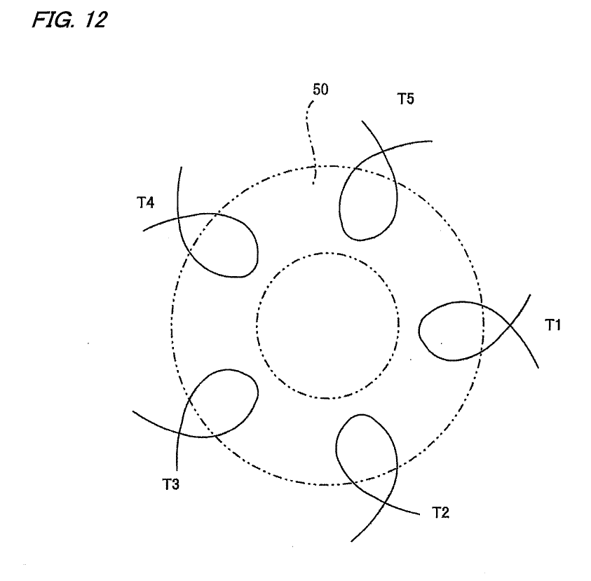

The speed ratio is not limited to the speed ratio of 16:15 as described above, and it is possible to rotate the rotary shafts 3, 4 with a speed ratio of N:K with N and K as natural numbers. For example, the speed ratio of the rotary shafts may be 5:4 as shown in FIG. 12. In this case, the trajectories T1 through T5 that the pin of one rotary shaft draws on the other disk surface produce a coarse pattern. However, the number of rotations of the disk until a period of one cycle of trajectory is reduced (5 or 4 rotations), and the raw material can be scraped off before the adhesion becomes strong. If N and K are set to a large value, the number of rotations of the disk until a period of one cycle of trajectory becomes large and the adhesion is likely to be strong. However, the trajectories produce a dense pattern as described above, so that N and K are preferably set to be larger than 5 or 4, for example, N=16 and K=15 as in this embodiment.

The pin is attached at a position radially away from the center of the disk, preferably at the outer peripheral position of the disk. The pin is brought closer to the facing rotary shaft by attaching it to the outer peripheral position of the disk in this manner, so that the raw material adhered to the rotary shaft can also be effectively scraped off. Although the pin 45 of the disk 40 and the pin 55 of the disk 50 are configured so as not to collide with each other as shown in FIGS. 10 and 11, the values of N and K may be decreased in the possible cases of collision. Alternatively, the pin diameter may be reduced or the radial position of the pin may be adjusted.

In the embodiment describe above, the raw material needs heating. In a case the raw material needs cooling, cooling water is supplied from the medium supply openings 32, 33. The cooling water is supplied and caused to flow from the hollow portions 3a, 4a of the rotary shafts 3, 4 through the inner pipes of the double pipes to the hollow portions of the disk blades 41, 41′ and 51, 51′. The raw material approaches or contacts the disk surface or the surface of the rotary shaft in the process of stirring and conveying, so that the raw material is cooled as it advances toward the discharge opening 31. On the other hand, the cooling water is discharged from the medium discharge openings 34, 35.

In the above-described embodiment, the disk blades 41, 41′, 51, 51′ are made hollow, and the medium such as steam or cooling water is supplied to the hollow portions of the disk blades to heat or cool the raw material via the surfaces thereof. However, the disk blades 41, 41′, 51, 51′ do not necessarily have to be made hollow, and may not be hollow, especially when cooling the raw material. In the case where the disk blades are not made hollow, double pipes that are inserted into the hollow portions are also unnecessary. The steam or cooling water is supplied from the medium supply opening to the respective hollow portion of the rotary shaft and discharged from the medium discharge opening to heat or cool the raw material in this process.

In the process of cooling the raw material, the raw material may adhere strongly to the surfaces of the rotary shafts 3, 4 or the disks 40, 50 in some cases depending on the raw material. Also in such cases, the scraper members approach the facing disk surfaces with the trajectories drawn thereon varying, thereby increasing the effect of scraping the raw material for improvement in cooling efficiency even when the raw material needs cooling as in the case where it needs heating.

### KEY TO THE SYMBOLS

1 housing
3 rotary shaft (drive shaft)
4 rotary shaft (driven shaft)
5, 6, 7, 8 bearing
10 base
11 strut
12 gear box
13, 14 gear
15, 17 sprocket
18 motor
19 reduction gears
30 raw-material supply opening
31 raw-material discharge opening
32, 33 medium supply opening
34, 35 medium discharge opening
40 disk
41, 41′ disk blades
45, 45′ scraper member (pin)
46, 46′ double pipe
50 disk
51, 51′ disk blade
55, 55′ scraper member (pin)

1. An apparatus for heating or cooling a raw material in which a disk mounted on a rotary shaft is heated or cooled and the raw material is brought into contact with the disk surface, comprising:
first and second rotary shafts that are disposed in a facing manner;
a plurality of disks that are provided upright at intervals on the first rotary shaft;
a plurality of disks that are provided upright on the second rotary shaft so as to be shifted a predetermined distance from the disks of the first rotary shaft, respectively;
wherein a scraper member that enters between the surfaces of the facing adjacent disks to scrape the raw material is fixed to each disk of the first and second rotary shafts; and
the first and second rotary shafts are rotated at unequal speeds such that the scraper member approaches the facing disk surface with a trajectory drawn thereon varying.

2. An apparatus for heating or cooling a raw material according to claim 1, wherein the first and second rotary shafts are rotated with a speed ratio of N:K with N and K as natural numbers.

3. An apparatus for heating or cooling a raw material according to claim 2, wherein N and K are set to large numbers such that the scraper member approaches the surface of the facing disk with the trajectory drawn thereon varying densely.

4. An apparatus for heating or cooling a raw material according to claim 2, wherein N is sixteen and K is fifteen.

5. An apparatus for heating or cooling a raw material according to claim 4, wherein the scraper member is attached to the outer periphery of the disk.

6. An apparatus for heating or cooling a raw material according to claim 3, wherein the scraper member is attached to the outer periphery of the disk.

7. An apparatus for heating or cooling a raw material according to claim 2, wherein the scraper member is attached to the outer periphery of the disk.

8. An apparatus for heating or cooling a raw material according to claim 1, wherein the scraper member is attached to the outer periphery of the disk.
